(19) United States
(12) Patent Application Publication
(10) Pub. No.: US 2021/0249182 A1
(43) Pub. Date: Aug. 12, 2021

(54) COOLED TRANSFORMER FOR AN ENERGY STORAGE DEVICE

(71) Applicant: Carrier Corporation, Palm Beach Gardens, FL (US)

(72) Inventor: Rudolf Johannes Van Wijk, Waddinxveen (NL)

(21) Appl. No.: 17/251,227

(22) PCT Filed: Oct. 31, 2019
(86) PCT No.: PCT/US2019/059073

§ 371 Date: Dec. 11, 2020

Related U.S. Application Data
(60) Provisional application No. 62/758,802, filed on Nov. 12, 2018.

(51) Int. Cl. H01F 27/28; B60H 1/32; H01F 27/10; B60H 1/00

(52) U.S. Cl. CPC H01F 27/2876; B60H 1/3232; B60H 2001/00307; B60H 1/323; B60H 1/00271; H01F 27/10

(57) ABSTRACT

According to one embodiment, a cooled transformer including: a laminated core comprising a first core extension and a second core extension; a first inner coil circumferentially wrapped around the first core extension; a first outer coil circumferentially wrapped around the first core extension; the first outer coil being located radially outward from the first inner coil; a second inner coil circumferentially wrapped around the second core extension; a second outer coil circumferentially wrapped around the second core extension; the second outer coil being located radially outward from the second inner coil; and at least one cooling plate interposed between the first inner coil and the first outer coil.

### BACKGROUND

The embodiments herein generally relate to transport refrigeration systems and more specifically, the energy management of such transport refrigeration systems.

Typically, cold chain distribution systems are used to transport and distribute cargo, or more specifically perishable goods and environmentally sensitive goods (herein referred to as perishable goods) that may be susceptible to temperature, humidity, and other environmental factors. Perishable goods may include but are not limited to fruits, vegetables, grains, beans, nuts, eggs, dairy, seed, flowers, meat, poultry, fish, ice, and pharmaceuticals. Advantageously, cold chain distribution systems allow perishable goods to be effectively transported and distributed without damage or other undesirable effects.

Refrigerated vehicles and trailers are commonly used to transport perishable goods in a cold chain distribution system. A transport refrigeration system is mounted to the vehicles or to the trailer in operative association with a cargo space defined within the vehicles or trailer for maintaining a controlled temperature environment within the cargo space.

Conventionally, transport refrigeration systems used in connection with refrigerated vehicles and refrigerated trailers include a transportation refrigeration unit having a refrigerant compressor, a condenser with one or more associated condenser fans, an expansion device, and an evaporator with one or more associated evaporator fans, which are connected via appropriate refrigerant lines in a closed refrigerant flow circuit. Air or an air/gas mixture is drawn from the interior volume of the cargo space by means of the evaporator fan(s) associated with the evaporator, passed through the airside of the evaporator in heat exchange relationship with refrigerant whereby the refrigerant absorbs heat from the air, thereby cooling the air. The cooled air is then supplied back to the cargo space.

On commercially available transport refrigeration systems used in connection with refrigerated vehicles and refrigerated trailers, the compressor, and typically other components of the transportation refrigeration unit, must be powered during transit by a prime mover. In mechanically driven transport refrigeration systems the compressor is driven by the prime mover, either through a direct mechanical coupling or a belt drive, and other components, such as the condenser and evaporator fans are belt driven.

Transport refrigeration systems may also be electrically driven. In an electrically driven transport refrigeration system, a prime mover carried on and considered part of the transport refrigeration system, drives an AC synchronous generator that generates AC power. The generated AC power is used to power an electric motor for driving the refrigerant compressor of the transportation refrigeration unit and also powering electric AC fan motors for driving the condenser and evaporator motors and electric heaters associated with the evaporator. A more efficient method to power the electric motor is desired to reduce fuel usage.

### BRIEF DESCRIPTION

According to one embodiment, a cooled transformer is provided. The cooled transformer including: a laminated core including a first core extension and a second core extension; a first inner coil circumferentially wrapped around the first core extension; a first outer coil circumferentially wrapped around the first core extension; the first outer coil being located radially outward from the first inner coil; a second inner coil circumferentially wrapped around the second core extension; a second outer coil circumferentially wrapped around the second core extension; the second outer coil being located radially outward from the second inner coil; and at least one cooling plate interposed between the first inner coil and the first outer coil.

In addition to one or more of the features described above, or as an alternative, further embodiments of the transport refrigeration system may include that the at least one cooling plate interposed between the first inner coil and the first outer coil further includes: a first forward cooling plate interposed between the first inner coil and the first outer coil, the first forward cooling plate being located on a forward side of the cooled transformer; and a first rear cooling plate interposed between the first inner coil and the first outer coil, the first rear cooling plate being located on a rear side of the cooled transformer.

In addition to one or more of the features described above, or as an alternative, further embodiments of the transport refrigeration system may include: at least one cooling plate interposed between the second inner coil and the second outer coil.

In addition to one or more of the features described above, or as an alternative, further embodiments of the transport refrigeration system may include that the at least one cooling plate interposed between the second inner coil and the second outer coil further includes: a second forward cooling plate interposed between the second inner coil and the second outer coil, the second forward cooling plate being located on a forward side of the cooled transformer; and a second rear cooling plate interposed between the second inner coil and the second outer coil, the second rear cooling plate being located on a rear side of the cooled transformer.

In addition to one or more of the features described above, or as an alternative, further embodiments of the transport refrigeration system may include: at least one cooling plate interposed between the second inner coil and the second outer coil.

In addition to one or more of the features described above, or as an alternative, further embodiments of the transport refrigeration system may include: the at least one cooling plate interposed between the second inner coil and the second outer coil further includes: a second forward cooling plate interposed between the second inner coil and the second outer coil, the second forward cooling plate being located on the forward side of the cooled transformer; and a second rear cooling plate interposed between the second inner coil and the second outer coil, the second rear cooling plate being located on the rear side of the cooled transformer.

In addition to one or more of the features described above, or as an alternative, further embodiments of the transport refrigeration system may include that the at least one cooling plate interposed between the second inner coil and the second outer coil is in thermal communication with the at least one cooling plate interposed between the first inner coil and the first outer coil.

In addition to one or more of the features described above, or as an alternative, further embodiments of the transport refrigeration system may include that the at least one cooling plate interposed between the second inner coil and the second outer coil is not in thermal communication with the at least one cooling plate interposed between the first inner coil and the first outer coil.

In addition to one or more of the features described above, or as an alternative, further embodiments of the transport refrigeration system may include that the at least one cooling plate interposed between the first inner coil and the first outer coil includes one or more coolant passageways for liquid coolant.

In addition to one or more of the features described above, or as an alternative, further embodiments of the transport refrigeration system may include that the liquid coolant is water.

In addition to one or more of the features described above, or as an alternative, further embodiments of the transport refrigeration system may include that the laminate core further includes a third core extension.

In addition to one or more of the features described above, or as an alternative, further embodiments of the transport refrigeration system may include: a third inner coil circumferentially wrapped around the third core extension; and a third outer coil circumferentially wrapped around the third core extension; the third outer coil being located radially outward from the third inner coil.

In addition to one or more of the features described above, or as an alternative, further embodiments of the transport refrigeration system may include that the at least one cooling plate interposed between the first inner coil and the first outer coil further includes: a first forward cooling plate interposed between the first inner coil and the first outer coil, the first forward cooling plate being located on a forward side of the cooled transformer; and a first rear cooling plate interposed between the first inner coil and the first outer coil, the first rear cooling plate being located on a rear side of the cooled transformer.

In addition to one or more of the features described above, or as an alternative, further embodiments of the transport refrigeration system may include: a second forward cooling plate interposed between the second inner coil and the second outer coil, the second forward cooling plate being located on the forward side of the cooled transformer; a second rear cooling plate interposed between the second inner coil and the second outer coil, the second rear cooling plate being located on the rear side of the cooled transformer; a third forward cooling plate interposed between the third inner coil and the third outer coil, the third forward cooling plate being located on the forward side of the cooled transformer; and a third rear cooling plate interposed between the third inner coil and the third outer coil, the third rear cooling plate being located on the rear side of the cooled transformer.

In addition to one or more of the features described above, or as an alternative, further embodiments of the transport refrigeration system may include that the first forward cooling plate includes a first forward coolant passageway, the first rear cooling plate includes a first rear coolant passageway, the second forward cooling plate includes a second forward coolant passageway, the second rear cooling plate includes a second rear coolant passageway, the third forward cooling plate includes a third forward coolant passageway, and the third rear cooling plate includes a third rear coolant passageway.

In addition to one or more of the features described above, or as an alternative, further embodiments of the transport refrigeration system may include that the first forward coolant passageway is fluidly connected to a coolant inlet, the first forward coolant passageway is fluidly connected to the second forward coolant passageway, the second forward coolant passageway is fluidly connected to the third forward coolant passageway, the third forward coolant passageway is fluidly connected to the third rear coolant passageway, the third rear coolant passageway is fluidly connected to the second rear coolant passageway, the second rear coolant passageway is fluidly connected to the first rear coolant passageway, and the first rear coolant passageway is fluidly connected to a coolant outlet.

According to another embodiment, a refrigerated transportation system is provided. The refrigerated system including: a transportation refrigeration unit; an energy storage device configured to provide electrical power to the transportation refrigeration unit; and a cooled transformer electrically connecting the energy storage device to the transportation refrigeration unit, the cooled transformer including: a laminated core including a first core extension and a second core extension; a first inner coil circumferentially wrapped around the first core extension; a first outer coil circumferentially wrapped around the first core extension; the first outer coil being located radially outward from the first inner coil; a second inner coil circumferentially wrapped around the second core extension; a second outer coil circumferentially wrapped around the second core extension; the second outer coil being located radially outward from the second inner coil; and at least one cooling plate interposed between the first inner coil and the first outer coil.

According to another embodiment, a cooled transformer is provided. The cooled transformer including: a laminated core including a first core extension, a second core extension, and a third core extension; a first inner coil circumferentially wrapped around the first core extension; a first outer coil circumferentially wrapped around the first core extension; the first outer coil being located radially outward from the first inner coil; a second inner coil circumferentially wrapped around the second core extension; a second outer coil circumferentially wrapped around the second core extension; the second outer coil being located radially outward from the second inner coil; a third inner coil circumferentially wrapped around the third core extension; a third outer coil circumferentially wrapped around the third core extension; the third outer coil being located radially outward from the third inner coil; a first forward cooling plate interposed between the first inner coil and the first outer coil, the first forward cooling plate being located on a forward side of the cooled transformer; a first rear cooling plate interposed between the first inner coil and the first outer coil, the first rear cooling plate being located on a rear side of the cooled transformer; a second forward cooling plate interposed between the second inner coil and the second outer coil, the second forward cooling plate being located on the forward side of the cooled transformer; a second rear cooling plate interposed between the second inner coil and the second outer coil, the second rear cooling plate being located on the rear side of the cooled transformer; a third forward cooling plate interposed between the third inner coil and the third outer coil, the third forward cooling plate being located on the forward side of the cooled transformer; and a third rear cooling plate interposed between the third inner coil and the third outer coil, the third rear cooling plate being located on the rear side of the cooled transformer.

In addition to one or more of the features described above, or as an alternative, further embodiments of the transport refrigeration system may include that the first forward cooling plate includes a first forward coolant passageway, the first rear cooling plate includes a first rear coolant passageway, the second forward cooling plate includes a second forward coolant passageway, the second rear cooling plate includes a second rear coolant passageway, the third forward cooling plate includes a third forward coolant passageway, and the third rear cooling plate includes a third rear coolant passageway.

In addition to one or more of the features described above, or as an alternative, further embodiments of the transport refrigeration system may include that the first forward coolant passageway is fluidly connected to a coolant inlet, the first forward coolant passageway is fluidly connected to the second forward coolant passageway, the second forward coolant passageway is fluidly connected to the third forward coolant passageway, the third forward coolant passageway is fluidly connected to the third rear coolant passageway, the third rear coolant passageway is fluidly connected to the second rear coolant passageway, the second rear coolant passageway is fluidly connected to the first rear coolant passageway, and the first rear coolant passageway is fluidly connected to a coolant outlet.

Technical effects of embodiments of the present disclosure include embedding cooling plated interposed between an inner coil and an outer coil of a transformer.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 is a schematic illustration of a transport refrigeration system, according to an embodiment of the present disclosure;

FIG. 2 is an enlarged schematic illustration of a transportation refrigeration unit of the transport refrigeration system of FIG. 1, according to an embodiment of the present disclosure;

FIG. 3 is an isometric illustration of cooled transformer for use with the transportation refrigeration unit of the transport refrigeration system of FIG. 1, according to an embodiment of the present disclosure; and

FIG. 4 is a cross-sectional view of the cooled transformer of FIG. 3, according to an embodiment of the present disclosure.

### DETAILED DESCRIPTION

A detailed description of one or more embodiments of the disclosed apparatus and method are presented herein by way of exemplification and not limitation with reference to the Figures.

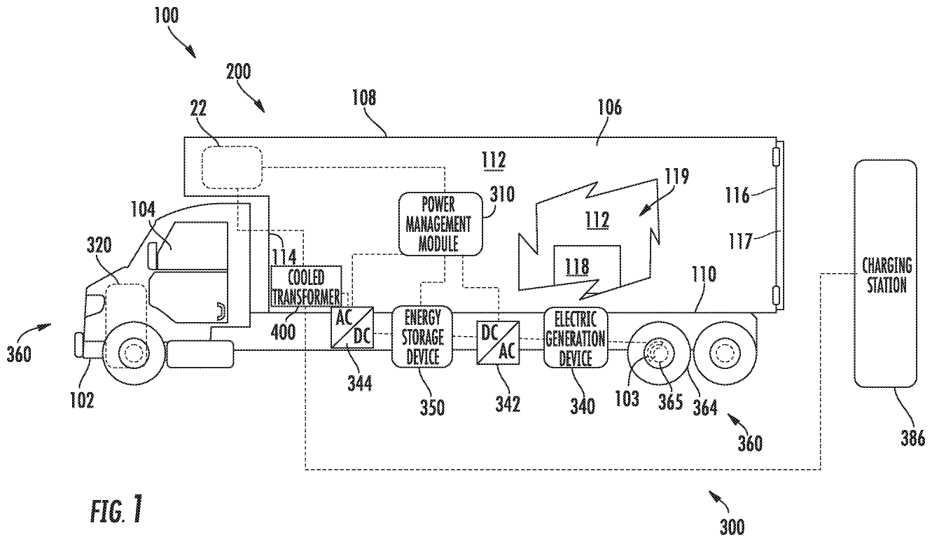

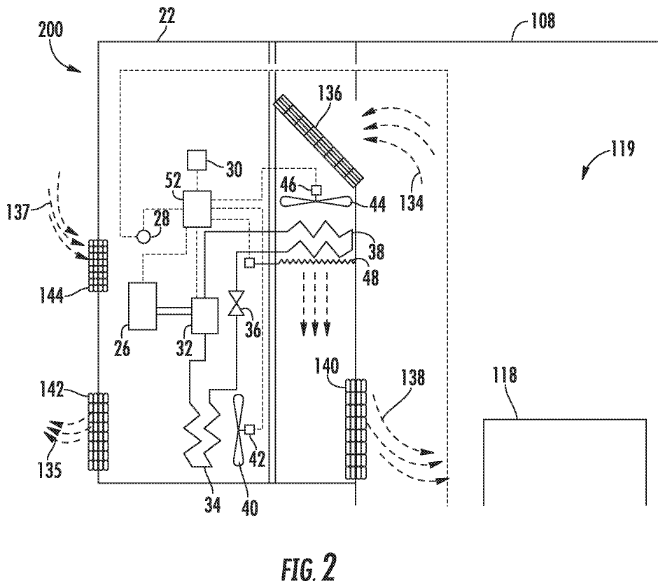

Referring to FIGS. 1 and 2, various embodiments of the present disclosure are illustrated. FIG. 1 shows a schematic illustration of a transport refrigeration system 200, according to an embodiment of the present disclosure. FIG. 2 shows an enlarged schematic illustration of the transport refrigeration system 200 of FIG. 1, according to an embodiment of the present disclosure.

The transport refrigeration system 200 is being illustrated as a trailer system 100, as seen in FIG. 1. The trailer system 100 includes a vehicle 102 integrally connected to a transport container 106. The vehicle 102 includes an operator's compartment or cab 104 and a propulsion motor 320 which acts as the drive system of the trailer system 100. The propulsion motor 320 is configured to power the vehicle 102. The energy source that powers the propulsion motor 320 may be at least one of compressed natural gas, liquefied natural gas, gasoline, electricity, diesel, or a combination thereof. The propulsion motor 320 may be an electric motor or a hybrid motor (e.g., a combustion engine and an electric motor). The transport container 106 is coupled to the vehicle 102. The transport container 106 may be removably coupled to the vehicle 102. The transport container 106 is a refrigerated trailer and includes a top wall 108, a directly opposed bottom wall 110, opposed side walls 112, and a front wall 114, with the front wall 114 being closest to the vehicle 102. The transport container 106 further includes a door or doors 117 at a rear wall 116, opposite the front wall 114. The walls of the transport container 106 define a refrigerated cargo space 119. It is appreciated by those of skill in the art that embodiments described herein may be applied to a tractor-trailer refrigerated system or non-trailer refrigeration such as, for example a rigid truck, a truck having refrigerated compartment.

Typically, transport refrigeration systems 200 are used to transport and distribute perishable goods and environmentally sensitive goods (herein referred to as perishable goods 118). The perishable goods 118 may include but are not limited to fruits, vegetables, grains, beans, nuts, eggs, dairy, seed, flowers, meat, poultry, fish, ice, blood, pharmaceuticals, or any other suitable cargo requiring temperature controlled transport. The transport refrigeration system 200 includes a transportation refrigeration unit 22, a refrigerant compression device 32, an electric motor 26 for driving the refrigerant compression device 32, and a controller 30. The transportation refrigeration unit 22 is in operative association with the refrigerated cargo space 112 and is configured to provide conditioned air to the transport container 106. The transportation refrigeration unit 22 functions, under the control of the controller 30, to establish and regulate a desired environmental parameters, such as, for example temperature, pressure, humidity, carbon dioxide, ethylene, ozone, light exposure, vibration exposure, and other conditions in the interior compartment 119, as known to one of ordinary skill in the art. In an embodiment, the transportation refrigeration unit 22 is capable of providing a desired temperature and humidity range.

The transportation refrigeration unit 22 includes a refrigerant compression device 32, a refrigerant heat rejection heat exchanger 34, an expansion device 36, and a refrigerant heat absorption heat exchanger 38 connected in refrigerant flow communication in a closed loop refrigerant circuit and arranged in a conventional refrigeration cycle. The transportation refrigeration unit 22 also includes one or more fans 40 associated with the refrigerant heat rejection heat exchanger 34 and driven by fan motor(s) 42 and one or more fans 44 associated with the refrigerant heat absorption heat exchanger 38 and driven by fan motor(s) 46. The transportation refrigeration unit 22 may also include a heater 48 associated with the refrigerant heat absorption heat exchanger 38. In an embodiment, the heater 48 may be an electric resistance heater. It is to be understood that other components (not shown) may be incorporated into the refrigerant circuit as desired, including for example, but not limited to, a suction modulation valve, a receiver, a filter/dryer, an economizer circuit.

The refrigerant heat rejection heat exchanger 34 may, for example, comprise one or more refrigerant conveying coiled tubes or one or more tube banks formed of a plurality of refrigerant conveying tubes across flow path to the heat outlet 142. The fan(s) 40 are operative to pass air, typically ambient air, across the tubes of the refrigerant heat rejection heat exchanger 34 to cool refrigerant vapor passing through the tubes. The refrigerant heat rejection heat exchanger 34 may operate either as a refrigerant condenser, such as if the transportation refrigeration unit 22 is operating in a subcritical refrigerant cycle or as a refrigerant gas cooler, such as if the transportation refrigeration unit 22 is operating in a transcritical cycle.

The refrigerant heat absorption heat exchanger 38 may, for example, also comprise one or more refrigerant conveying coiled tubes or one or more tube banks formed of a plurality of refrigerant conveying tubes extending across flow path from a return air inlet 136. The fan(s) 44 are operative to pass air drawn from the refrigerated cargo space 119 across the tubes of the refrigerant heat absorption heat exchanger 38 to heat and evaporate refrigerant liquid passing through the tubes and cool the air. The air cooled in traversing the refrigerant heat rejection heat exchanger 38 is supplied back to the refrigerated cargo space 119 through a refrigeration unit outlet 140. It is to be understood that the term “air” when used herein with reference to the atmosphere within the cargo box includes mixtures of air with other gases, such as for example, but not limited to, nitrogen or carbon dioxide, sometimes introduced into a refrigerated cargo box for transport of perishable produce.

Airflow is circulated into and through the refrigerate cargo space 119 of the transport container 106 by means of the transportation refrigeration unit 22. A return airflow 134 flows into the transportation refrigeration unit 22 from the refrigerated cargo space 119 through the refrigeration unit return air intake 136, and across the refrigerant heat absorption heat exchanger 38 via the fan 44, thus conditioning the return airflow 134 to a selected or predetermined temperature. The conditioned return airflow 134, now referred to as supply airflow 138, is supplied into the refrigerated cargo space 119 of the transport container 106 through the refrigeration unit outlet 140. Heat 135 is removed from the refrigerant heat rejection heat exchanger 34 through the heat outlet 142. The transportation refrigeration unit 22 may contain an external air inlet 144, as shown in FIG. 2, to aid in the removal of heat 135 from the refrigerant heat rejection heat exchanger 34 by pulling in external air 137. The supply airflow 138 may cool the perishable goods 118 in the refrigerated cargo space 119 of the transport container 106. It is to be appreciated that the transportation refrigeration unit 22 can further be operated in reverse to warm the container system 106 when, for example, the outside temperature is very low. In the illustrated embodiment, the return air intake 136, the refrigeration unit outlet 140, the heat outlet 142, and the external air inlet 144 are configured as grilles to help prevent foreign objects from entering the transportation refrigeration unit 22.

The transport refrigeration system 200 also includes a controller 30 configured for controlling the operation of the transport refrigeration system 200 including, but not limited to, the operation of various components of the refrigerant unit 22 to provide and maintain a desired thermal environment within the refrigerated cargo space 119. The controller 30 may also be able to selectively operate the electric motor 26. The controller 30 may be an electronic controller including a processor and an associated memory comprising computer-executable instructions that, when executed by the processor, cause the processor to perform various operations. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be a storage device such as, for example, a random access memory (RAM), read only memory (ROM), or other electronic, optical, magnetic or any other computer readable medium.

The transportation refrigeration unit 22 is powered by the energy storage device 350, which provides electrical power to the transportation refrigeration unit 22 and will be discussed further below. Examples of the energy storage device 350 may include a battery system (e.g., a battery or bank of batteries), fuel cells, flow battery, and others devices capable of storing and outputting electric energy that may be DC. The energy storage device 350 may include a battery system, which may employ multiple batteries organized into battery banks.

The energy storage device 350 may be charged by a stationary charging station 386 such as, for example a wall 48V power outlet. The charging station 386 may provide single phase (e.g., level 2 charging capability) or three phase AC power to the energy storage device 350. It is understood that the charging station 386 may have any phase charging and embodiments disclosed herein are not limited to single phase or three phase AC power. In an embodiment, the single phase AC power may be a high voltage DC power, such as, for example, 500 VDC.

In one embodiment, the energy storage device 350 is located outside of the transportation refrigeration unit 22, as shown in FIG. 1. In another embodiment, the energy storage device 350 is located within the transportation refrigeration unit 22. The transportation refrigeration unit 22 has a plurality of electrical power demand loads on the energy storage device 350, including, but not limited to, the drive motor 42 for the fan 40 associated with the refrigerant heat rejection heat exchanger 34, and the drive motor 46 for the fan 44 associated with the refrigerant heat absorption heat exchanger 38. As each of the fan motors 42, 46 and the electric motor 26 may be an AC motor or a DC motor, it is to be understood that various power converters 52, such as AC to DC rectifiers, DC to AC inverters, AC to AC voltage/frequency converters, and DC to DC voltage converters, may be employed in connection with the energy storage device 350 as appropriate. The power converter 52 may or may not be required depending upon the power requirements, locations, and electrical connections of the transportation refrigeration unit 22 and energy storage device 350. In the depicted embodiment, the heater 48 also constitutes an electrical power demand load. The electric resistance heater 48 may be selectively operated by the controller 30 whenever a control temperature within the temperature controlled cargo box drops below a preset lower temperature limit, which may occur in a cold ambient environment. In such an event the controller 30 would activate the heater 48 to heat air circulated over the heater 48 by the fan(s) 44 associated with the refrigerant heat absorption heat exchanger 38. The heater 48 may also be used to de-ice the return air intake 136. Additionally, the electric motor 26 being used to power the refrigerant compression device 32 also constitutes a demand load. The refrigerant compression device 32 may comprise a single-stage or multiple-stage compressor such as, for example, a reciprocating compressor or a scroll compressor. The transport refrigeration system 200 may also include a voltage sensor 28 to sense the voltage from the energy storage device 350.

As described above the energy storage device 350 is used to electrical power the transportation refrigeration unit 22. The energy storage device 350 is integrated within an energy management system 300. The energy management system 300 comprises an electric generation device 340, the energy storage device 350 configured to provide electrical power to electric motor 26, the electric motor 26 configured to power the transportation refrigeration unit 22, a power management module 310, and a cooled transformer 400.

The electric generation device 340 is configured to harvest electrical power from kinetic energy of the trailer system 100. The electric generation device 340 can be at least one of an axle generator and a hub generator mounted configured to recover rotational energy when the transport refrigeration system 20 is in motion and convert that rotational energy to electrical energy, such as, for example, when the axle 365 of the trailer system 100 is rotating due to acceleration, cruising, or braking. The electric generation device 340 may be mounted on or operably connected to a wheel axle 365 of the trailer system 100 and the hub generator may be mounted on a wheel 364 of the trailer system 100. It is understood that the electric generation device 340 may be mounted on any wheel 364 or axle 365 of the trailer system 100 and the mounting location of the electric generation device 340 illustrated in FIG. 1 is one example of a mounting location.

The electric generation device 340 will then use the generated electrical power to charge the energy storage device 350. In an alternate embodiment, the electric generation device 340 may be operably connected to the wheel axle 365 or wheel 364 through at least one mechanical linkage, such as, for example a drive shaft, belt system, or gear system. The mechanical linkage is configured to rotate the electric generation device 340 as the wheels 364 or wheel axle 365 rotates when the electric generation device 340 is activated. The electric generation device 340 may comprise a single on-board, engine driven AC generator configured to generate alternating current (AC) power including at least one AC voltage at one or more frequencies. In an embodiment, the electric generation device 340 may, for example, be a permanent magnet AC generator, asynchronous, or a synchronous AC generator. In another embodiment, the electric generation device 340 may comprise a single on-board, engine driven DC generator configured to generate direct current (DC) power at at least one voltage. The DC power may be then converted by a 342 DC/AC inverter 342 prior to charging the energy storage device 350.

The power management module 310 may be in electronic communication with the energy storage device, the transportation refrigeration unit 22, the AC/DC inverter 342, and the AC/DC inverter 344. The power management module 310 may be an electronic controller including a processor and an associated memory comprising computer-executable instructions that, when executed by the processor, cause the processor to perform various operations. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be a storage device such as, for example, a random access memory (RAM), read only memory (ROM), or other electronic, optical, magnetic or any other computer readable medium.

The cooled transformer 400 electrically connects the energy storage device 350 to the power management module 310 and the transportation refrigeration unit 22. The cooled transformer 400 works as a voltage step-up or step-down, thus eliminating the need for a DC-DC converter. The cooled transformer 400 works as an isolator helping isolate the electric circuit (energy storage device 350, and the electric generation device 340) from the truck 102 and grid power from a charging station 386. An AC/DC invertor 344 may be located interposed between the cooled transformer 400 to convert AC grid power from the charging station 286 to DC power for the energy storage device. The cooled transformer 400 works as an EMI filter without unwanted ground leakage. One of the characteristics of an AC transformer is that they can be used as Sinus EMI filter.

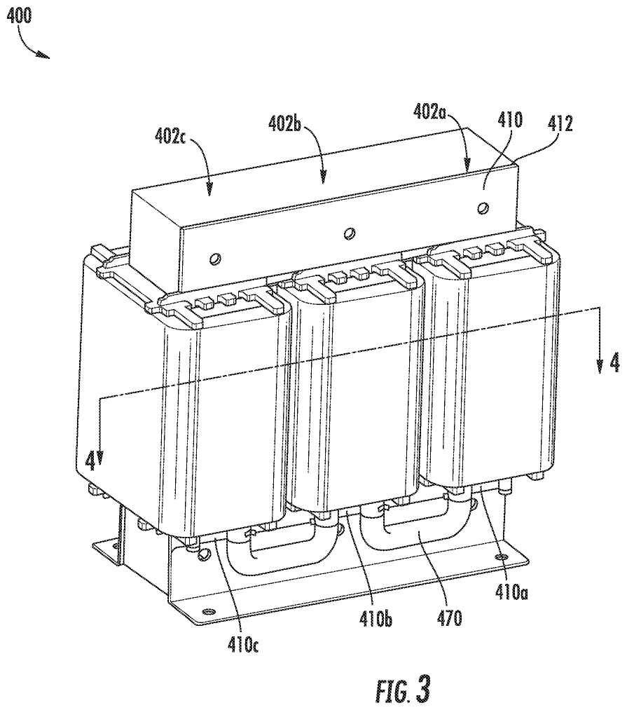

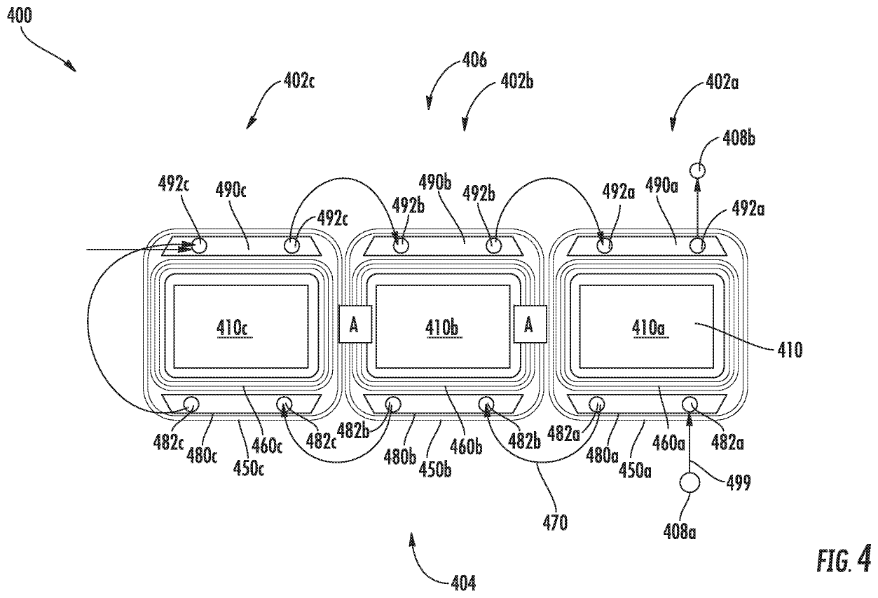

Referring now to FIGS. 3 and 4, with continued reference to FIGS. 1 and 2, the cooled transformer 400 is illustrated, in accordance with an embodiment of the present disclosure. In the illustrated embodiment of FIGS. 3 and 4, the cooled transformer 400 is a three-phase transformer including a first phase 402a, a second phase 402b, and a third phase 402c. It is understood that while a three phase transformer is illustrated, embodiments disclosed herein may be applied to any cooled transformer having one or more phases. The cooled transformer 400 includes a laminated core 410 composed of a plurality of laminations 412 (i.e., layers). Each lamination 412 may be composed of a ferromagnetic material, such as for example, steel. The laminated core 410 may be a shell-type lamination having “E-I” shaped lamination or “E-E” shaped laminations. The laminated core 240 includes a first core extension 410a of the first phase 402a, a second core extension 410b of the second phase 402b, and a third core extension 410c of the third phase 402c.

Each phase 402a-402c may include an inner coil 460a-460c and an outer coil 450a-450c. The inner coils 460a-460c may be called primary coils and outer coils 450a-450c may be called secondary coil. The primary coil is connected to the inverter and secondary coil is connector to the refrigeration unit 22 or grid (e.g., charging station 386). In an embodiment, a ratio of the cooled transformer 400 may be 1:2.5. The inner coils 460a-460c are each wrapped circumferentially around their respective core extension 410a-410c. For example, the first inner coil 460a is wrapped circumferentially around the first core extension 410a, the second inner coil 460b is wrapped circumferentially around the second core extension 410b, and the third inner coil 460c is wrapped circumferentially around the third core extension 410c. The outer coils 450a-450c are each wrapped circumferentially around their respective core extension 410a-410c. For example, the first outer coil 450a is wrapped circumferentially around the first core extension 410a, the second outer coil 450b is wrapped circumferentially around the second core extension 410b, and the third outer coil 450c is wrapped circumferentially around the third core extension 410c. The outer coils 450a-450c are located radially outward from the inner coils 460a-460c. For example, the first outer coil 450a is located radially outward from the first inner coil 460a, the second outer coil 450b is located radially outward from the second inner coil 460b, and the third outer coil 450c is located radially outward from the third inner coil 460c. The outer coils 450a-450c each wrapped circumferentially around their inner coils 460a-460c. For example, the first outer coil 450a is wrapped circumferentially around the first inner coil 460a, the second outer coil 450b is wrapped circumferentially around the second inner coil 460b, and the third outer coil 450c is wrapped circumferentially around the third inner coil 460c.

Each phase 402a-402c includes one or more cooling plates 480a-480c, 490a-490c interposed between the inner coils 460a-460c and the outer coils 450a-450c. In the illustrated embodiment of FIGS. 3 and 4, each phase 402a-402c has two cooling plates 480a-480c, 490a-490c, which includes a forward cooling plate 480a-480c located on a forward side 404 of the cooled transformer 400 and a rear cooling plate 490a-490c located on a rear side 406 of the cooled transformer 400. The cooling plates 480a-480c, 490a-490c are configured to absorb heat from each phase 402a-402c of the transformer 400 and remove the heat from the transformer 400. In the illustrated embodiment of FIGS. 3 and 4, each of the cooling plates 480a-480c, 490a-490c are liquid cooled using a liquid coolant 491, such as, for example, air, water, refrigerant, or water glycol mix. In an embodiment, the liquid coolant 491 is water. The liquid coolant 491 may be passed through one or more coolant passageways 482a-482c, 492a-492c in each coolant plate 480a-480c, 490a-490c. The coolant passageways 482a-482c, 492a-492c may be singe-pass, two-pass, or multiple pass fluid passageways. In the embodiment shown in FIG. 4, the coolant passageways 482a-482c, 492a-492c are two-pass fluid passageways. The liquid coolant 491 may flow through the coolant plates 480a-480c, 490a-490c in parallel or series. When the coolant passageways 482a-482c, 492a-492c are fluidly connected in series then the coolant plates 480a-480c, 490a-490c are in thermal communication. When the coolant passageways 482a-482c, 492a-492c are in parallel then the coolant plates 480a-480c, 490a-490c are not in thermal communication. In the embodiment shown in FIG. 4, the coolant passageways 482a-482c, 492a-492c are fluidly connected in parallel such that the first forward coolant passageway 482a of the first forward cooling plate 480a is fluidly connected to the second forward coolant passageway 482b of the second forward cooling plate 480b, the second forward coolant passageway 482b of the second forward cooling plate 480b is fluidly connected to the third forward coolant passageway 482c of the third forward cooling plate 480c, the third forward coolant passageway 482c of the third forward cooling plate 480c is fluidly connected to the third rear coolant passageway 492c of the third rear cooling plate 490c, the third rear coolant passageway 492c of the third rear cooling plate 490c is fluidly connected the second rear coolant passageway 492b of the second rear cooling plate 490b, the second rear coolant passageway 492b of the second rear cooling plate 490b is fluidly connected to the first rear coolant passageway 492a of the first rear cooling plate 490a. The first forward coolant passageway 482a may be fluidly connected to a coolant inlet 408a of the transformer 400 and the first rear coolant passageway 492b may be fluidly connected to a coolant outlet 408b of the transformer 400.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A cooled transformer, comprising:
a laminated core comprising a first core extension and a second core extension;
a first inner coil circumferentially wrapped around the first core extension;
a first outer coil circumferentially wrapped around the first core extension; the first outer coil being located radially outward from the first inner coil;
a second inner coil circumferentially wrapped around the second core extension;
a second outer coil circumferentially wrapped around the second core extension; the second outer coil being located radially outward from the second inner coil; and
at least one cooling plate interposed between the first inner coil and the first outer coil.

2. The cooled transformer of claim 1, wherein the at least one cooling plate interposed between the first inner coil and the first outer coil further comprises:
a first forward cooling plate interposed between the first inner coil and the first outer coil, the first forward cooling plate being located on a forward side of the cooled transformer; and
a first rear cooling plate interposed between the first inner coil and the first outer coil, the first rear cooling plate being located on a rear side of the cooled transformer.

3. The cooled transformer of claim 1, further comprising:
at least one cooling plate interposed between the second inner coil and the second outer coil.

4. The cooled transformer of claim 3, wherein the at least one cooling plate interposed between the second inner coil and the second outer coil further comprises:
a second forward cooling plate interposed between the second inner coil and the second outer coil, the second forward cooling plate being located on a forward side of the cooled transformer; and
a second rear cooling plate interposed between the second inner coil and the second outer coil, the second rear cooling plate being located on a rear side of the cooled transformer.

5. The cooled transformer of claim 2, further comprising:
at least one cooling plate interposed between the second inner coil and the second outer coil.

6. The cooled transformer of claim 5, wherein the at least one cooling plate interposed between the second inner coil and the second outer coil further comprises:
a second forward cooling plate interposed between the second inner coil and the second outer coil, the second forward cooling plate being located on the forward side of the cooled transformer; and
a second rear cooling plate interposed between the second inner coil and the second outer coil, the second rear cooling plate being located on the rear side of the cooled transformer.

7. The cooled transformer of claim 3, wherein the at least one cooling plate interposed between the second inner coil and the second outer coil is in thermal communication with the at least one cooling plate interposed between the first inner coil and the first outer coil.

8. The cooled transformer of claim 3, wherein the at least one cooling plate interposed between the second inner coil and the second outer coil is not in thermal communication with the at least one cooling plate interposed between the first inner coil and the first outer coil.

9. The cooled transformer of claim 3, wherein the at least one cooling plate interposed between the first inner coil and the first outer coil includes one or more coolant passageways for liquid coolant.

10. The cooled transformer of claim 3, wherein the liquid coolant is water.

11. The cooled transformer of claim 1, wherein the laminate core further comprises a third core extension.

12. The cooled transformer of claim 11, further comprising:
a third inner coil circumferentially wrapped around the third core extension; and
a third outer coil circumferentially wrapped around the third core extension; the third outer coil being located radially outward from the third inner coil.

13. The cooled transformer of claim 12, wherein the at least one cooling plate interposed between the first inner coil and the first outer coil further comprises:
a first forward cooling plate interposed between the first inner coil and the first outer coil, the first forward cooling plate being located on a forward side of the cooled transformer; and
a first rear cooling plate interposed between the first inner coil and the first outer coil, the first rear cooling plate being located on a rear side of the cooled transformer.

14. The cooled transformer of claim 13, further comprising:
a second forward cooling plate interposed between the second inner coil and the second outer coil, the second forward cooling plate being located on the forward side of the cooled transformer;
a second rear cooling plate interposed between the second inner coil and the second outer coil, the second rear cooling plate being located on the rear side of the cooled transformer;
a third forward cooling plate interposed between the third inner coil and the third outer coil, the third forward cooling plate being located on the forward side of the cooled transformer; and
a third rear cooling plate interposed between the third inner coil and the third outer coil, the third rear cooling plate being located on the rear side of the cooled transformer.

15. The cooled transformer of claim 14, wherein:
the first forward cooling plate includes a first forward coolant passageway,
the first rear cooling plate includes a first rear coolant passageway,
the second forward cooling plate includes a second forward coolant passageway,
the second rear cooling plate includes a second rear coolant passageway,
the third forward cooling plate includes a third forward coolant passageway, and
the third rear cooling plate includes a third rear coolant passageway.

16. The cooled transformer of claim 15, wherein:
the first forward coolant passageway is fluidly connected to a coolant inlet,
the first forward coolant passageway is fluidly connected to the second forward coolant passageway,
the second forward coolant passageway is fluidly connected to the third forward coolant passageway,
the third forward coolant passageway is fluidly connected to the third rear coolant passageway,
the third rear coolant passageway is fluidly connected to the second rear coolant passageway,
the second rear coolant passageway is fluidly connected to the first rear coolant passageway, and
the first rear coolant passageway is fluidly connected to a coolant outlet.

17. A refrigerated transportation system, comprising:
a transportation refrigeration unit;
an energy storage device configured to provide electrical power to the transportation refrigeration unit; and
a cooled transformer electrically connecting the energy storage device to the transportation refrigeration unit, the cooled transformer comprising:
a laminated core comprising a first core extension and a second core extension;
a first inner coil circumferentially wrapped around the first core extension;
a first outer coil circumferentially wrapped around the first core extension; the first outer coil being located radially outward from the first inner coil;
a second inner coil circumferentially wrapped around the second core extension;
a second outer coil circumferentially wrapped around the second core extension; the second outer coil being located radially outward from the second inner coil; and
at least one cooling plate interposed between the first inner coil and the first outer coil.

18. A cooled transformer, comprising:
a laminated core comprising a first core extension, a second core extension, and a third core extension;
a first inner coil circumferentially wrapped around the first core extension;
a first outer coil circumferentially wrapped around the first core extension; the first outer coil being located radially outward from the first inner coil;
a second inner coil circumferentially wrapped around the second core extension;
a second outer coil circumferentially wrapped around the second core extension; the second outer coil being located radially outward from the second inner coil;
a third inner coil circumferentially wrapped around the third core extension;
a third outer coil circumferentially wrapped around the third core extension; the third outer coil being located radially outward from the third inner coil;
a first forward cooling plate interposed between the first inner coil and the first outer coil, the first forward cooling plate being located on a forward side of the cooled transformer;
a first rear cooling plate interposed between the first inner coil and the first outer coil, the first rear cooling plate being located on a rear side of the cooled transformer;
a second forward cooling plate interposed between the second inner coil and the second outer coil, the second forward cooling plate being located on the forward side of the cooled transformer;
a second rear cooling plate interposed between the second inner coil and the second outer coil, the second rear cooling plate being located on the rear side of the cooled transformer;
a third forward cooling plate interposed between the third inner coil and the third outer coil, the third forward cooling plate being located on the forward side of the cooled transformer; and
a third rear cooling plate interposed between the third inner coil and the third outer coil, the third rear cooling plate being located on the rear side of the cooled transformer.

19. The cooled transformer of claim 18, wherein:
the first forward cooling plate includes a first forward coolant passageway,
the first rear cooling plate includes a first rear coolant passageway,
the second forward cooling plate includes a second forward coolant passageway,
the second rear cooling plate includes a second rear coolant passageway,
the third forward cooling plate includes a third forward coolant passageway, and
the third rear cooling plate includes a third rear coolant passageway.

20. The cooled transformer of claim 19, wherein:
the first forward coolant passageway is fluidly connected to a coolant inlet,
the first forward coolant passageway is fluidly connected to the second forward coolant passageway,
the second forward coolant passageway is fluidly connected to the third forward coolant passageway,
the third forward coolant passageway is fluidly connected to the third rear coolant passageway,
the third rear coolant passageway is fluidly connected to the second rear coolant passageway,
the second rear coolant passageway is fluidly connected to the first rear coolant passageway, and
the first rear coolant passageway is fluidly connected to a coolant outlet.
